(19) United States
(12) Patent Application Publication
(10) Pub. No.: US 2026/0127658 A1
(43) Pub. Date: May 7, 2026

(54) SYSTEMS AND METHODS FOR ARTIFICIAL INTELLIGENCE ARCHITECTURE PLATFORMS

(71) Applicant: IcecapAI, Inc., Denver, CO (US)

(72) Inventors: Michael TERPIN, San Juan (PR); Jacques VOORHEES, Dillon, CO (US); Krista OLSON-BLUNDELL, Dillon, CO (US); Alex VOORHEES, Tokyo (JP)

(73) Assignee: IcecapAI, Inc., Denver, CO (US)

(21) Appl. No.: 19/377,881

(22) Filed: Nov. 3, 2025

Related U.S. Application Data
(60) Provisional application No. 63/716,030, filed on Nov. 4, 2024.

(51) Int. Cl. G06Q 30/0601; G06N 3/088

(52) U.S. Cl. CPC G06Q 30/0641; G06N 3/088

(57) ABSTRACT

A computer-implemented method including: receiving, by a controller and from a first electronic application associated with a first electronic device, user data associated with an interaction; determining, based on the user data, user behavior associated with the interaction; generating, based on first criteria, a first operator associated with the user behavior and user data; generating, based on the first operator and second criteria, a first sequence; transmitting, based on the generating, the first sequence to the first electronic application; generating, based on first user feedback and the first criteria, a second operator; generating, based on the second operator and the second criteria, a second sequence; transmitting, based on the generating, the second sequence to the first electronic application; encoding, based on second user feedback, a first payload, the first payload including one or more factors for modifying the interaction; and transmit the payload to at least one remote system.

### CROSS-REFERENCE TO RELATED APPLICATIONS

This application claims the benefit of priority to U.S. Provisional Application No. 63/716,030, filed Nov. 4, 2024, which is incorporated herein by reference in its entirety.

### TECHNICAL FIELD

Various embodiments of the present disclosure relate generally to artificial intelligence architecture platforms and, more particularly, to systems and methods for employing artificial intelligence platforms as a negotiating AI agents during a user interaction.

### INTRODUCTION

Recently, consumer purchasing behavior has shifted significantly toward online shopping platforms rather than traditional in-person retail environments. This transition may have limited the ability of merchants to engage directly with customers during the purchasing process. In physical retail settings, sales personnel are able to observe a customer's body language, tone, and emotional cues to assess client satisfaction or hesitation, allowing for real-time adjustments such as personalized product recommendations, assistance in decision-making, or negotiation of terms. Online retail systems, however, generally lack this human-to-human feedback loop. As a result, merchants are unable to dynamically interpret a client's intent or emotional state, which may lead to lost sales opportunities and reduced customer satisfaction due to unmet needs or insufficient support during the transaction process.

Unless otherwise indicated herein, the techniques and information described in this section are not prior art to the claims in this application and are not admitted to be prior art, or suggestions of the prior art, by inclusion in this section.

### SUMMARY

In some aspects, the techniques described herein relate to a computer-implemented method including: receiving, by a controller and from a first electronic application associated with a first electronic device, user data associated with an interaction; determining, based on analyzing the user data, user behavior associated with the interaction, wherein the analyzing is performed by specialized hardware accelerators configured for real-time behavioral pattern detection; generating, based on first criteria, a first operator associated with the user behavior and user data, wherein the first operator includes one or more first parameters, and wherein the first operator is generated using a multi-layered convolutional neural network with temporal pattern recognition capabilities; generating, based on the first operator and second criteria, a first sequence, wherein the first sequence maps to the one or more first parameters of the first operator; transmitting, based on the generating, the first sequence to the first electronic application; generating, based on first user feedback and the first criteria, a second operator, wherein the second operator includes an incremental modification of the first operator; generating, based on the second operator and the second criteria, a second sequence, wherein the second sequence maps to one or more second parameters of the second operator; transmitting, based on the generating, the second sequence to the first electronic application; encoding, based on second user feedback, a first payload, the first payload including one or more factors for modifying the interaction; displaying, via the user device, an indication of the one or more factors of the first payload; and in response to a request to complete the interaction and an indication that the one or more factors are satisfied, transmit the payload to at least one remote system.

In some aspects, the techniques described herein relate to a computer-implemented method, wherein the controller includes an artificial intelligence (AI) orchestration layer.

In some aspects, the techniques described herein relate to a computer-implemented method, wherein generating the second operator includes contextual data.

In some aspects, the techniques described herein relate to a computer-implemented method, wherein transmitting the second sequence includes displaying the second sequence via a pop-up user interface on the first electronic device.

In some aspects, the techniques described herein relate to a computer-implemented method, wherein analyzing the user data includes determining whether a user behavior metric surpasses a predetermined threshold.

In some aspects, the techniques described herein relate to a computer-implemented method, wherein the wherein the at least one remote system includes an application programming interface associated with a second electronic device.

In some aspects, the techniques described herein relate to a computer-implemented method, further including transmitting the first payload in response to receiving an authenticated payload over a standard secure protocol.

In some aspects, the techniques described herein relate to a non-transitory computer readable medium including one or more programming instructions, which, when executed by a processor, causes a computing system to perform operations including: receiving, by a controller and from a first electronic application associated with a first electronic device, user data associated with an interaction; determining, based on analyzing the user data, user behavior associated with the interaction, wherein the analyzing is performed by specialized hardware accelerators configured for real-time behavioral pattern detection; generating, based on first criteria, a first operator associated with the user behavior and user data, wherein the first operator includes one or more first parameters, and wherein the first operator is generated using a multi-layered convolutional neural network with temporal pattern recognition capabilities; generating, based on the first operator and second criteria, a first sequence, wherein the first sequence maps to the one or more first parameters of the first operator; transmitting, based on the generating, the first sequence to the first electronic application; encoding, based on first user feedback, a first payload, the first payload including one or more factors for modifying the interaction; displaying, via the user device, an indication of the one or more factors of the first payload; and in response to a request to complete the interaction and an indication that the one or more factors satisfies a predetermined threshold, transmit the payload to at least one remote system.

In some aspects, the techniques described herein relate to a non-transitory computer readable medium, wherein the first electronic application is a browser extension, and the interaction is associated with a website visited by a web browser also operating on the first electronic device.

In some aspects, the techniques described herein relate to a non-transitory computer readable medium, the controller includes an artificial intelligence (AI) module that controls one or more conversational AI agents.

In some aspects, the techniques described herein relate to a non-transitory computer readable medium, wherein generating the first operator includes contextual data.

In some aspects, the techniques described herein relate to a non-transitory computer readable medium, wherein transmitting the first sequence includes displaying the first sequence via a pop-up user interface on the first electronic device.

In some aspects, the techniques described herein relate to a non-transitory computer readable medium, wherein encoding the first payload includes encrypting the first payload.

In some aspects, the techniques described herein relate to a non-transitory computer readable medium, wherein the wherein the at least one remote system includes a representational state transfer application programming interface associated with a second electronic device.

In some aspects, the techniques described herein relate to a system, including: a processor; and a memory having programming instructions stored thereon, which, when executed by the processor, causes the system to perform operations including: receiving, by a controller and from a first electronic application associated with a first electronic device, user data associated with an interaction; generating, based on first criteria, a first operator, wherein the first operator includes one or more first parameters, and wherein the first operator is generated using a multi-layered convolutional neural network with temporal pattern recognition capabilities; generating, based on the first operator and second criteria, a first sequence, wherein the first sequence maps to the one or more first parameters of the first operator; transmitting, based on the generating, the first sequence to the first electronic application; generating, based on first user feedback and the first criteria, a second operator, wherein the second operator includes an incremental modification of the first operator associated with the one or more first parameters; generating, based on the second operator and the second criteria, a second sequence, wherein the second sequence maps to one or more second parameters of the second operator; transmitting, based on the generating, the second sequence to the first electronic application; encoding, based on second user feedback, a first payload, the first payload including one or more factors for modifying the interaction; displaying, via the user device, an indication of the one or more factors of the first payload; and in response to a request to complete the interaction, transmit the payload to at least one remote system.

In some aspects, the techniques described herein relate to a system, wherein the controller includes an artificial intelligence (AI) orchestration layer including a large language model.

In some aspects, the techniques described herein relate to a system, wherein the controller determines one or more rules associated with the first sequence or the second sequence.

In some aspects, the techniques described herein relate to a system, wherein the controller monitors user behavior during the interaction.

In some aspects, the techniques described herein relate to a system, wherein the first user feedback and the second user feedback is real-time feedback.

In some aspects, the techniques described herein relate to a system, wherein the first operator or the second operator is based on dynamically populated templates.

It is to be understood that both the foregoing general description and the following detailed description are exemplary and explanatory only and are not restrictive of the disclosed embodiments, as claimed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 depicts a block diagram illustrating a computing environment, according to example embodiments.

FIG. 2 depicts a method of generating a personalized offer according to example embodiments.

FIG. 3 depicts a diagram of a deep neural network architecture according to example embodiments.

FIG. 4 depicts a flow diagram for training a machine-learning model, according to example embodiments according to example embodiments.

FIG. 5 depicts a system including an orchestration layer according to example embodiments.

FIG. 6 depicts an example AI architecture according to example embodiments.

FIG. 7 depicts an AI communication module according to example embodiments.

FIG. 8 depicts an example method of interacting with an AI communication module according to example embodiments.

FIG. 9 depicts a flowchart of an example of interacting with an AI offer module according to example embodiments.

FIG. 10 depicts an example negotiation based on a discount code according to example embodiments.

FIG. 11 depicts an example negotiation based on an offer for expedited shipping according to example embodiments.

FIG. 12 depicts a simplified functional block diagram of a computer system, according to one or more embodiments according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various embodiments of the present disclosure relate generally to artificial intelligence architecture platforms and, more particularly, to systems and methods for employing artificial intelligence platforms as a negotiating AI agents during a user interaction.

In some embodiments, artificial intelligence platforms disclosed herein may employ specific neural network architectures including transformer models, recurrent neural networks, and convolutional neural networks to process user interaction data. The systems may utilize large language models as foundational components for natural language understanding and generation, combined with specialized machine learning algorithms for behavioral pattern recognition and intent detection. The platforms may implement real-time data processing capabilities to analyze conversation context, sentiment analysis, and purchase intent indicators during active user sessions.

The AI orchestration layer may implement a distributed neural network architecture comprising multiple specialized processing nodes. In some embodiments, the system may utilize a transformer-based attention mechanism with multi-head self-attention layers specifically configured for real-time conversation analysis. The neural network may include an encoder-decoder architecture with at least 12 transformer blocks, each containing 768-dimensional hidden states and 12 attention heads optimized for processing sequential user interaction data.

The system may implement custom hardware acceleration through application-specific integrated circuits (ASICs) designed for neural network inference. These ASICs may include dedicated tensor processing units with specialized matrix multiplication hardware that reduces computational latency for offer generation from traditional CPU processing times of 2-3 seconds to under 200 milliseconds.

One or more embodiments may provide for a conversational AI system designed to increase e-commerce conversions by detecting buying intent, negotiating personalized offers, and learning from each interaction, both successful and unsuccessful. The system may operate with an orchestration layer for a network of conversational AI agents (AI-bots) that interact with online shoppers through chat interfaces. Each conversational AI agent may analyze customer behavior, create or retrieve unique discount codes through vendor APIs, and optimize future decisions based on aggregate performance data. Additionally, the system may generate and adjust promotional offers dynamically in real time and refine its strategies automatically across multiple vendors.

One or more embodiments may provide for a system employing AI-generated sales assistants (e.g., AI-bots) to deliver an interest-specific referral code and engage in bargaining with an online customer. In this way, merchants or venders may increase a closing rate for e-commerce sales. The AI-based sales bots (e.g., AI-bots) may answer customer questions, provide alternative or additional options, etc. in online environments. Shoppers interacting in real-time with the novel AI architecture may improve the closing rate of visitors-to-sales on e-commerce websites. While the AI-bot may charge subscription fees to the vendor, an alternate or supplemental option for merchants may be to use the AI-bot to create on-the-fly, referral based discount codes. When used by a shopper, these referral based discount codes may generate transaction revenue (via referral fees) from the vendor to the operator of the AI-bot system.

One or more embodiments may connect the AI-bot to vendor storefronts through a representational state transfer application programming interface (e.g. RESTful APIs) and webhooks. A typical data flow may begin when a shopper begins to chat with a user interface and the conversation may be routed to an AI agent, such as a conversational AI-bot. The AI agent may detect that the shopper intends to purchase an item and an orchestrator may request a code generation to incite or accelerate the purchase. An offer generator may compose an API request to an e-commerce platform. The e-commerce platform may return a discount code. The AI agent may then present the discount code to the shopper as an incentive to complete the purchase. Finally, the customer may complete the interaction by checking out using the discount code. The AI agent may include a learning module for learning service records associated with one or more events. The learning model may update asynchronously with the shopper interactions. Databases may be used to store structured vendor policies, product catalogs, and anonymized session logs for determining discount codes and other incentives. Standard encryption may protect all in-transit and stored data. The system may be designed to be platform-agnostic and can integrate with major commerce frameworks such as Shopify, WooCommerce, or Magento.

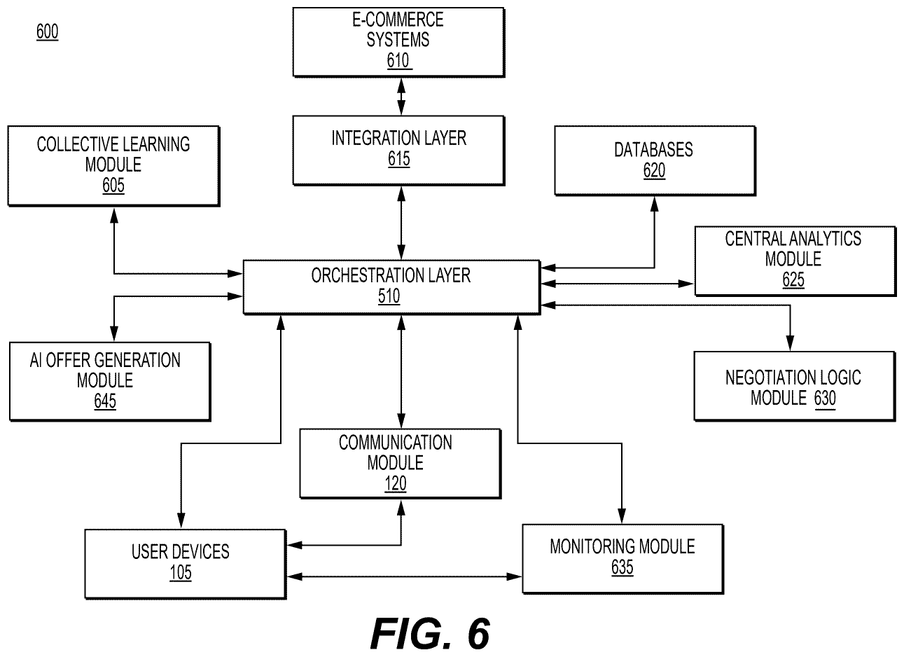

The system may integrate with e-commerce platforms through standardized APIs including REST, GraphQL, and webhook implementations. In some embodiments, the integration layer 615 of FIG. 6, as further disclosed herein, may support connections to major processing platforms, commerce platforms, and/or custom merchant systems. API communications may utilize OAuth 2.0 authentication protocols and HTTPS encryption for secure data transmission.

Real-time inventory synchronization may be achieved through webhook notifications and periodic API polling mechanisms. The system may maintain local caches of product availability data, updating inventory status within 1-5 seconds of changes in merchant systems. Price synchronization may occur in real-time to ensure offer calculations reflect current product pricing and promotional campaigns.

Payment processing integration may support multiple payment gateways including Stripe, PayPal, Square, and merchant-specific processors. The system may handle discount code application during checkout processes, ensuring proper calculation of final prices and tax adjustments. Integration with order management systems may enable tracking of transaction completion rates and post-purchase customer satisfaction metrics.

For example, an online shopper may be looking at blue dresses. Conversational AI-bot 120 may ask the customer either if they're ready to purchase or if they'd be interested in a discount code to achieve a specific percent discount on the blue dress. If the customer says yes, conversational AI-bot 120 may generate a discount in real time. The code may include parameters and/or constraints such as who may receive the referral credit based on various inputs. The various inputs may include an amount of credit, a time of day, current over/under stocked situation, specials being run at that moment by backend suppliers, expiration time, and other relevant parameters. Additional characteristics may include those to help close sales, motivate buyer behavior, and data from multiple parties.

Conversational AI-bot 120 may be instructed in various ways in terms of what codes to offer, how to offer them, when to offer them, on what products, and multiple other input streams. Machine learning and data experience may harvest information on how effective such discount codes are, in what contexts, and properties that make the codes more effective. For example, if offered at the moment the AI conversation begins, the codes will probably be not as effective (in terms of motivating a sale, or causing an upsale, or multiple sales) as if they are instead offered at some stage in the conversation. The timing of when to offer what code (e.g., incentive) may be learned during any stage in the conversation. In some situations, the most effective time to offer a code (e.g., incentive) may be where conversational AI-bot 120 has learned customer is “on the verge” of deciding to make a purchase. The most effective time to offer a code (e.g., incentive) may be based on types of products being searched, demographics of the buyer, and other factors related to the customer, product, or other relevant parameter.

The actions of the conversational AI-bot may be tied in to the identity of the consumer, in a variety of ways. For example, the AI system may generate or receive user history data of a prior customer. In some instances, the user history data may include details of that customer that might help the AI system determine how a discount could be best applied. The user history data may be acquired through an opt-in (self-identification) by customer. Additionally, user history data may be accessed through a database containing information associated with the identity of the customer and improve its interaction accordingly.

For example, user history information may provide critical insights into individual shopping preferences. This information may be leveraged to optimize personalized recommendations in online retail systems. Key sources of such information may include browsing and interaction data, such as pages visited, time spent on specific products, clickstream sequences, search queries, and interactions with promotional content or recommendations. Purchase history, including previously bought items, order frequency, recency, average order value, payment preferences, and fulfillment choices, further informs predictive models. Engagement and behavioral signals, such as responses to discounts or special offers, wish lists, product reviews, social sharing behavior, and ratings, provide additional context about user intent and preferences. Demographic and device information, including location, device type, browser, and account status, may help tailor experiences to user context, while temporal and environmental factors, such as time of day, day of the week, and seasonal patterns, reveal habitual behaviors. External signals, including interactions with emails, push notifications, and social media campaigns, may offer complementary data for understanding user engagement. Collectively, this comprehensive history may allow AI systems to identify patterns, predict preferences, and deliver highly personalized recommendations, enhancing user satisfaction and driving engagement.

Additionally, conversational AI-bot 120 may ask the consumer to fill out a survey, in return for the discount code. The customer thus may “earn” the discount, by providing personal information. This information could of course be added to a database for future use, but could equally be used in real time during the very session in which the survey is completed. For example, one of the questions on the survey may include a “favorite color” inquiry. The customer may reveal that their favorite color is “blue.” The conversational AI-bot may then use that information during the sales and negotiation process to offer versions of the product under discussion in blue.

Other promotional devices may be part of a “quiver” the AI system may use, if it wishes, in the attempt to close a sale. For example, in addition to a simple discount code for a purchase today, conversational AI-bot 120 may offer other sweeteners, provided in an almost unlimited quantity. For example, conversational AI-bot 120 may propose that if the customer buys the product in question today, then earn a discount coupon applicable to any future purchase made in the next 12 months. In some instances, conversational AI-bot 120 may offer a buy today, and earn a gift coupon to some external vendor. The external vendor may include the customer's favorite restaurant, an upcoming sporting event, a travel industry vendor, etc. Additionally, conversational AI-bot 120 may offer a “buy today and earn a discount coupon to any of our partner vendors” incentive. The offer may include a list of companies not competitive to the vendor, but in adjacent industries. For example, if the vendor is a jewelry vender, the partner vendors may include other luxury goods industries.

Additional incentives merchants and AI-bots may employ during an online interaction with a customer may include discounts, cashback offers, loyalty or rewards programs, free or upgraded shipping, bulk or bundle pricing, deferred payment options, gift cards, referral bonuses, and other offers. These mechanisms may reduce perceived cost barriers and create ongoing value for repeat transactions. Non-financial incentives, such as exclusive access to new or limited products, personalized recommendations, gamified experiences, social recognition, and convenience-based perks like priority service or flexible returns, may enhance the overall customer experience and emotional connection to the brand. Additionally, sustainability-driven incentives, such as rewards for environmentally responsible choices, may appeal to socially conscious consumers. When applied strategically, these incentive models may help increase conversion rates, improve customer retention, and differentiate merchants in competitive digital marketplaces.

Future actions may be offered to the consumer by the conversational AI-bot by such statements as “if you're busy right now, may I send you a link to this item you appear to be interested in, 30 days from now, so you can reconsider at that time?” In this way, conversational AI-bot 120 may capture an email address and other contact information of the consumer. Additional offers may include statements such as “would you like me to schedule an in-person meeting with the store manager, who may be able to offer you more information, a great array of products, and/or further discounts, etc.?” These statements may prompt customer engagement and convey that the customer's input is valued, thereby improving the overall experience and fostering stronger consumer loyalty and retention.

Rewards for help in viral marketing may also be offered. For example, rewards such as “if you are enjoying this shopping experience, what other vendors would you like to see have this same shopping-assistant capability? Please list in space provided below. If any choose to add this capability, we will send you a further discount code you can use at any of the vendors who are our customers.” Offering rewards for participation in viral marketing campaigns may provide multiple strategic benefits for both merchants and consumers. By incentivizing users to share products, promotions, or brand content within their personal networks, businesses can significantly expand their reach through authentic, peer-driven promotion rather than relying solely on paid advertising. This approach leverages social trust, as recommendations from friends or influencers are often more persuasive than traditional marketing messages. Reward structures, such as points, discounts, exclusive access, or monetary bonuses, may motivate users to actively engage, creating a cycle of participation and organic growth. Additionally, viral marketing rewards may increase brand visibility, drive higher conversion rates from referred traffic, and strengthen community engagement by turning customers into brand advocates. Over time, this strategy may not only reduce customer acquisition costs but also may foster long-term loyalty through meaningful, value-based interactions.

In some embodiments, conversational AI-bot 120 may implement survey mechanisms as part of the negotiation process. The system may present users with targeted questions designed to gather preference data in exchange for discount codes or other incentives. Survey questions may be dynamically generated based on user behavioral patterns and may include inquiries about color preferences, size requirements, budget constraints, or intended use cases for products under consideration.

The system may implement viral marketing reward mechanisms to encourage user engagement and platform expansion. In some aspects, users may be offered additional incentives for sharing product information on social media platforms, referring friends to merchant websites, or providing feedback about their shopping experience. The viral marketing system may track referral success rates and adjust reward parameters to optimize user participation and merchant benefit.

Future engagement scheduling capabilities may allow the system to maintain contact with users beyond individual shopping sessions. The system may offer to send product links, price alerts, or promotional offers at specified future dates. In some embodiments, users may schedule in-person consultations with merchant representatives, with the AI system coordinating appointment scheduling and providing relevant user preference data to sales personnel.

A conversational AI-bot may be taught to actually engage in haggling (negotiating) with a customer, in terms of what can be offered. For example, conversational AI-bot 120 may be trained to say “Ma′am, if you're willing to make a decision today, I'm authorized—for the next ten minutes—to provide you a 10%-off coupon for this specific purchase.” The customer may reply: “Well, I'm not quite decided yet. Although if you could make it 20%, I'd do it.” Conversational AI-bot 120 may reply with: “I can't go to 20%. Hmmm. OK, best I can do is 15%, but that's only if we do this immediately.” In this way, conversational AI-bot 120 may negotiate with the client to determine a best offer for all parties involved.

Additionally, a backend module may control conversational AI-bot 120. The backend module may learn how to be the most interactive, and is able to use all such interactions, across multiple vendor sites, to inform its training, and to become more adept. Additionally, the backend module (or conversational AI-bot) may harvest negotiating techniques and apply successful ones to other customers. For example, what the backend module learns during interactions with Vendor A may be applied to interactions with Vendor B. A database of “techniques” and “best practices” may be created, and this knowledge may better inform future AI-bots. In short, the system may be constantly monitoring AI-bot and client interactions to learn more effective negotiating techniques for various users and situations, by using the various techniques and inducements described herein.

The integration of artificial intelligence (AI) into online retail platforms may provide substantial performance and efficiency improvements compared to conventional e-commerce systems. AI-driven emotional recognition and adaptive recommendation engines may enhance customer engagement and increase the likelihood of purchase completion relative to static, rule-based systems. Response times may be improved through real-time data processing, allowing the system to deliver personalized offers, unique negotiations, and improved assistance almost instantaneously. The use of model optimization and distributed processing may reduce computational overhead, enabling faster decision-making with lower energy and resource requirements. Furthermore, the system architecture centered around the orchestration layer may be designed for scalability, allowing it to manage a large number of simultaneous users without performance degradation or latency issues. Collectively, these enhancements may enable a more intelligent, efficient, and scalable retail experience that more closely replicates the personalized interaction of in-person shopping.

Further, traditional e-commerce systems face several technical challenges in generating and managing real-time offers, particularly when adapting promotions to individual customer behavior. The proposed AI-based system addresses these challenges by using centralized dynamic data modeling and predictive analytics to generate personalized offers in real time, eliminating the latency and rigidity of pre-programmed discount logic. Through direct integration with existing e-commerce platforms via, for example, APIs, the novel AI system may ensure seamless interoperability without requiring major hardware changes or downtime. Unlike conventional discount code systems that rely on static rule sets, this AI-driven approach continuously learns from user interactions to refine offer relevance and optimize incentive timing. These technical improvements may result in a more adaptive, optimized resource utilization, and efficient promotional infrastructure that may enhance both system performance and customer experience.

Additionally, employing an orchestration layer as the central hub of an AI architecture may address several complex technical problems by providing coordinated, automated, and intelligent management of distributed system components. For example, the orchestration layer may serve as a central command system that ensures all components of an AI ecosystem work together seamlessly and efficiently. The orchestration layer may automate complex workflows, optimize resource utilization, and scale operations dynamically based on demand and user preferences, thereby reducing downtime, operational costs, and manual oversight. By intelligently coordinating data pipelines, modules, and services, the orchestration layer may provide greater reliability, faster response times, and improved system resilience. In essence, the orchestration layer may transform AI operations into a self-managing, high-performance environment that supports business agility, scalability, and consistent delivery of results.

The uniquely derived codes, produced by the AI system, may enhance security and privacy by acting as dynamic, one-time identifiers during online transactions or interactions. These codes may limit the exposure of personally identifiable information, making it significantly harder for malicious actors to intercept or misuse user data. The codes may also provide traceability and accountability without compromising anonymity, allowing systems to validate actions or permissions securely. Importantly, the AI system may control exactly where and how each code is transferred, ensuring that sensitive information is only transmitted to authorized endpoints. Furthermore, uniquely derived codes may be integrated with encryption and tokenization frameworks, adding an additional layer of protection for communications and transactions. This approach not only safeguards user privacy but may also strengthen system integrity, reduce the potential for fraud, and ensure a more secure and trustworthy digital experience.

The disclosed AI system provides specific technical improvements over conventional e-commerce platforms by implementing a novel real-time behavioral analysis pipeline that processes user interaction data through multiple specialized neural network layers. Unlike traditional rule-based systems that rely on predetermined decision trees, the system dynamically adjusts negotiation parameters through continuous learning algorithms that update model weights based on interaction outcomes.

The system achieves technical improvements in memory efficiency by implementing a hierarchical caching system that stores frequently accessed user behavioral patterns in high-speed memory while maintaining less common patterns in secondary storage. This architecture reduces memory access latency by 40-60% compared to conventional database-driven approaches and enables real-time processing of concurrent user sessions without performance degradation.

One or more embodiments may provide for a dynamic, real-time negotiation. In some instances, the negotiation may replace static coupons with context-driven, single-use codes generated on demand. Employing conversational AI-bots may lead to faster decision-making and immediate API interaction which may reduce customer drop-off between interest and checkout. One or more embodiments may provide for adaptive optimization including automatic learning across vendors thereby improving success rates without manual rule-tuning. One or more embodiments may provide for scalable architecture that includes multi-agent orchestration which support multiple concurrent store sessions with low latency. One or more embodiments may provide for privacy-aware analytics while collective learning operates on anonymized behavioral data, ensuring compliance and vendor control.

The system may implement comprehensive data encryption protocols for protecting user information and transaction data. In some embodiments, all data transmissions may utilize AES-256 encryption standards, with additional layers of protection for sensitive financial information. User identifiers may be hashed using cryptographic algorithms to prevent unauthorized access while maintaining system functionality for personalization and learning purposes.

Privacy-preserving analytics techniques may enable collective learning while protecting individual user data. The system may employ differential privacy methods to add statistical noise to aggregated data, preventing identification of individual users while maintaining the utility of behavioral insights. Data anonymization processes may remove or obfuscate personally identifiable information before storage in collective learning databases.

Access control mechanisms may restrict system functionality based on user roles and authentication levels. Merchant administrators may have access to their own store data and performance metrics, while system operators may access aggregated analytics without exposure to individual merchant or customer information. Audit logging may track all system access and data modifications for security monitoring and compliance purposes.

The AI-driven negotiation system may provide measurable improvements in e-commerce performance metrics compared to traditional static discount systems. Based on experimental data collected by implementing the AI-driven negotiation system in a test environment, conversion rates may increase by 15-40% through personalized offer timing and dynamic discount generation. Cart abandonment rates may be reduced by 20-35% through real-time intervention and negotiation capabilities. Average order values may increase by 10-25% through strategic upselling and cross-selling recommendations integrated into the negotiation process.

System response times may be optimized to deliver personalized offers within 200-500 milliseconds of detecting purchase intent. The architecture may support concurrent processing of over 1000 simultaneous user sessions while maintaining sub-second response times for offer generation and code validation. Memory usage may be optimized through efficient data caching strategies, reducing computational overhead by 30-50% compared to traditional rule-based systems.

The collective learning capabilities may enable continuous improvement in negotiation effectiveness across merchant platforms. Success rate improvements of 5-15% may be achieved monthly through automated analysis of interaction outcomes and strategy refinement. The system may identify optimal offer timing patterns, with some implementations showing 25-60% higher acceptance rates when offers are presented at algorithmically determined moments during user interactions.

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

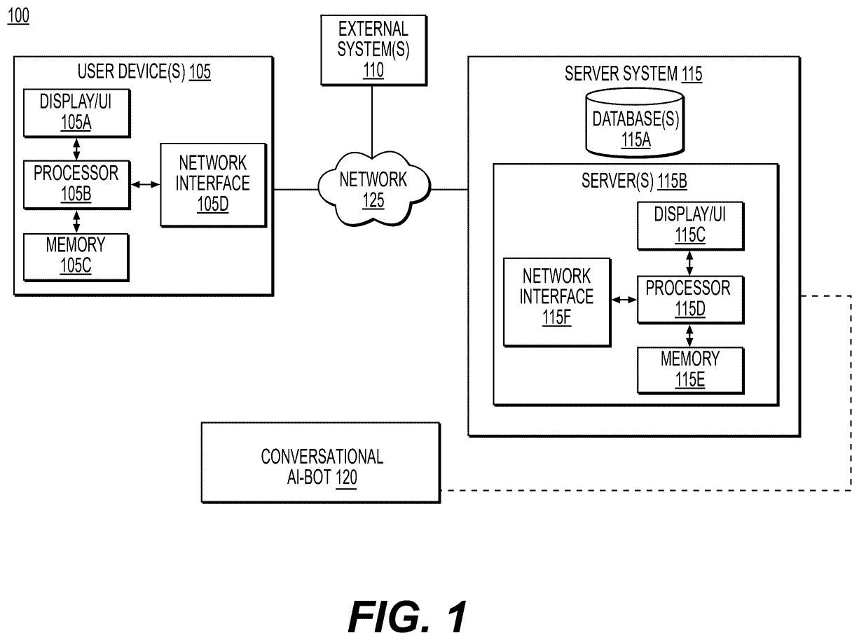

FIG. 1 depicts a block diagram illustrating a computing environment 100, according to example embodiments. Computing environment 100 may include user device 105, external system(s) 110, server system 115 and network 125. User device 105 may include one or more user devices. External system(s) 110 may include one or more external systems. Server system 115 may include one or more server systems. User device 105, external system(s) 110, and server system 115 may communicate across a network 125. As will be discussed in further detail below, the server system 115 may communicate with one or more of the other components of the environment 100 across the network 125.

In some aspects, the components of the environment 100 may be associated with a common entity (e.g., a single business or organization, etc.). Alternatively, one or more of the components may be associated with a different entity than another. The systems and devices of environment 100 may communicate in any arrangement. For example, the user device 105 may be associated with one or more online consumers, external system(s) 110 may be associated with one or more clients or service subscribers, and the server system 115 may be associated with a conversational AI provider.

The user device 105 may be associated with a user, e.g., an on-line shopper. The user device 105 may be configured to enable the user to access and/or interact with other systems in the environment 100. For example, the user device 105 may be a computer system such as, for example, a desktop computer, a laptop, a mobile device, a tablet device, a wearable device, etc. The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S, API, browser extension etc.), system control software, system monitoring software, software development tools, or the like. In some aspects, the electronic application may be associated with one or more of the other components in the environment 100, such as the server system 115. The application may manage the memory 105C, such as a database, to transmit streaming data to the network 125. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 125. The processor 105B, while executing the application, may generate data and/or receive user inputs from the display/UI 105A and/or receive/transmit messages to the server system 115, and may further perform one or more operations prior to providing an output to the network 125.

The electronic application, executed by the processor 105B of the user device 105, may generate one or more user interfaces that can be accessed, viewed, and/or interacted with by a user of the user device 105. More particularly, the electronic application may be associated or in communication with conversational AI-bot 120 via server system 115. As described further below, conversational AI-bot 120 may include a conversational AI-bot interface to communicate one or more offers to a user of user device 105 during an online shopping interaction. Additionally, the AI-bot may monitor user behavior and user online interactions through conversational AI-bot 120 via, for example, an API associated with user device 105. For example, a user of user device 105 may interact with conversational AI-bot 120 via the electronic application (e.g., API) to obtain receive and negotiate one or more offers. The one or more offers may be associated with one or more products affiliated with a user's online shopping interaction.

In various aspects, the network 125 may be a wide area network (“WAN”), a local area network (“LAN”), a personal area network (“PAN”), or the like. In some aspects, the network 125 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The external system(s) 110 may be, for example, one or more third party and/or auxiliary systems that integrate and/or communicate with the server system 115 in performing various information extraction tasks. The external system(s) 110 may be in communication with other device(s) or system(s) in the environment 100 over the network 125. For example, the external system(s) 110 may communicate with the server system 115 via application programming interface (API) access over the network 125, and also communicate with the user device 105 via web browser access over the network 125. Non-limiting examples of the external system(s) 110 may include one or more merchants, vendors, payment processors, financial institutions, suppliers, inventory management systems, shipping and logistics providers, authentication and identity verification services, fraud detection systems, marketing and analytics platforms, customer support partners, cloud hosting services, data storage providers, and notification or messaging gateways.

Although depicted as separate components in FIG. 1, it should be understood that a component or portion of a component in the environment 100 may, in some aspects, be integrated with or incorporated into one or more other components. For example, a portion of the display/UI 115C may be integrated into the user device 105 or the like. In some aspects, operations or aspects of one or more of the components listed above may be distributed amongst one or more other components. Any suitable arrangement and/or integration of the various systems and devices of the environment 100 may be used. Furthermore, it should be understood that while only one user device is shown in FIG. 1, the environment 100 may include a plurality of user device 105 that are configured to communicate with the server system 115 over the network 125.

In some aspects, server system 115 includes and/or interacts with an application programming interface for exchanging data to other systems, e.g., one or more of the other components of the environment. The server system 115 may include and/or act as the host for an application platform (e.g., conversational AI-bot 120) that may be accessible by the user device 105.

Server system 115 may include one or more database(s) 115A and one or more server(s) 115B. Server system 115 may be a computer, system of computers (e.g., rack server(s)), and/or a cloud service computer system. Server system 115 may store or have access to database(s) 115A (e.g., hosted on a third party server or in memory 115E). Server(s) 115B may include a display/UI 115C, a processor 115D, a memory 115E, and/or a network interface 115F. The display/UI 115C may be a touch screen or a display with other input systems (e.g., mouse, keyboard, etc.) for an operator of the server(s) 115B to control the functions of the server(s) 115B. The server system 115 may execute, by the processor 115D, an operating system (O/S) and at least one instance of a servlet program (each stored in the memory 115E). When the user device 105 transmits input to the server system 115, the received dataset and/or dataset information may be stored in the memory 115E or the database(s) 115A. The network interface 115F may be a TCP/IP network interface, e.g., Ethernet or wireless communications with the network 125.

Processor 115D may include and/or execute instructions to direct the operation of a conversational AI-bot by executing instructions that coordinate its various components. For example, processor 115D may receive input from user device 105 to a conversational AI-bot logic (see FIG. 6 below) via conversational AI-bot 120. Conversational AI-bot 120 logic may analyze and structure the information. Processor 115D may then use conversational AI-bot 120 to transmit conversational AI-bot 120's response back to user device 105, ensuring that messages are formatted correctly and delivered through the appropriate channels. In essence, processor 115D may coordinate the flow of data between conversational AI-bot 120 logic and user device 105 via conversational AI-bot 120, enabling interactive and responsive exchanges. Alternatively, AI-bot logic may communication directly with user device 105 via conversational AI-bot 120.

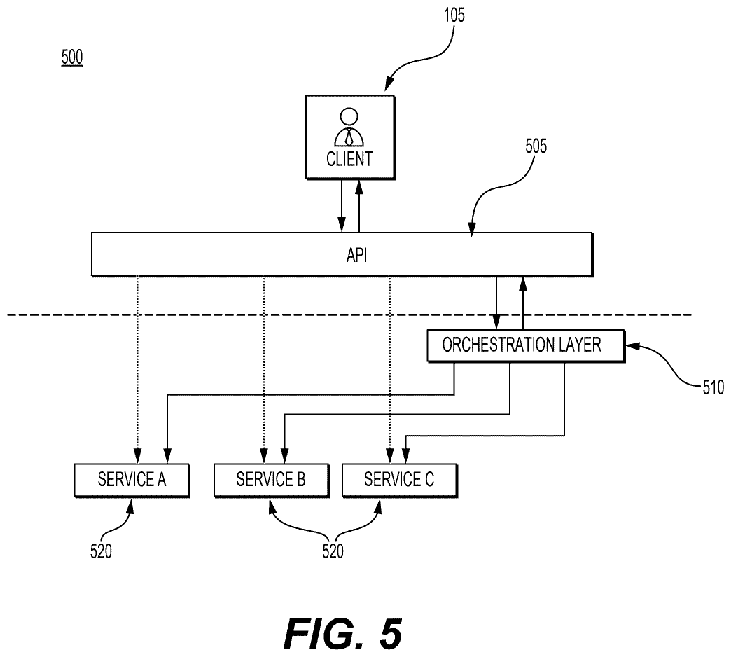

A conversational AI-bot 120 may include a user interaction that may receive input from and send output to user device 105. An orchestration layer 510, see FIGS. 5 and 6 below, may decide which internal modules should handle a given task and manages the flow of information between components. One or more AI interpretation modules, often a machine-learning or neural-network model, may analyze input, extract meaning, and generate structured instructions. An integration layer (e.g., integration layer 615) may enable communication with external systems or services, such as external system(s) 110, and may standardize data formats. A data layer or module may store and retrieves information, such as to and from database(s) 115A, and an output layer may format the results for presentation. Memory 115E, processor 115D, and network interface 115F may support all layers by executing operations, temporarily storing data, and enabling communication.

The conversational AI-bot 120 may be implemented using specialized hardware components including field-programmable gate arrays (FPGAs) configured with custom logic circuits for natural language processing tasks. The FPGA implementation may include dedicated hardware accelerators for tokenization, embedding lookup, and attention computation, providing 5-10× performance improvements over general-purpose processors for language model inference.

The system may utilize distributed processing across multiple graphics processing units (GPUs) with custom CUDA kernels optimized for parallel execution of neural network operations. Memory management may be optimized through custom allocation strategies that minimize data transfer between CPU and GPU memory, reducing processing latency for real-time conversation analysis.

Conversational AI-bots may be built on a layered architecture of machine learning and AI models that work together to interpret and respond to user input. Natural language understanding (NLU) models, such as transformer-based architectures like BERT or GPT, are often used to recognize user intent and extract entities from text. Dialogue management models, which may use reinforcement learning or sequence-to-sequence models, maintain conversational context and decide the next action. Response generation models can range from template-based systems to generative models like GPT for crafting natural-sounding replies. Additionally, classification models may be used to route queries to specialized submodules, while embedding models translate words or sentences into vector representations that allow semantic similarity searches.

Machine learning models used in AI-bots include supervised, unsupervised, and reinforcement learning models, each serving different purposes such as classification, clustering, or decision-making. Neural networks commonly employed include feedforward networks for basic pattern recognition, recurrent neural networks (RNNs) and LSTMs for handling sequential and temporal data like conversations, transformers for advanced natural language understanding, and convolutional neural networks (CNNs) for processing structured or visual data. These networks may be combined or layered to enhance performance across multiple conversational tasks.

The AI architecture may employ multiple neural network configurations working in coordination to achieve optimal performance. In some aspects, transformer-based models such as BERT or GPT variants may be utilized for natural language understanding and processing user inputs. Recurrent neural networks (RNNs) and Long Short-Term Memory (LSTM) networks may handle sequential conversation data and maintain context across extended interactions. Convolutional neural networks may process structured data patterns and user behavioral signals.

The system architecture may include distributed processing capabilities to handle multiple concurrent user sessions with minimal latency. In some embodiments, the orchestration layer 510 may implement load balancing algorithms to distribute computational tasks across multiple processing nodes. The architecture may support horizontal scaling, allowing additional processing capacity to be added dynamically based on user demand and system load metrics.

Database schemas may be optimized for rapid retrieval of user profiles, product information, and negotiation rules. In some aspects, the databases 620 may employ indexing strategies and caching mechanisms to reduce query response times. Data structures may be designed to support real-time updates of user behavioral patterns, offer success rates, and merchant policy changes. The system may implement data partitioning strategies to maintain performance as the volume of stored interactions increases.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

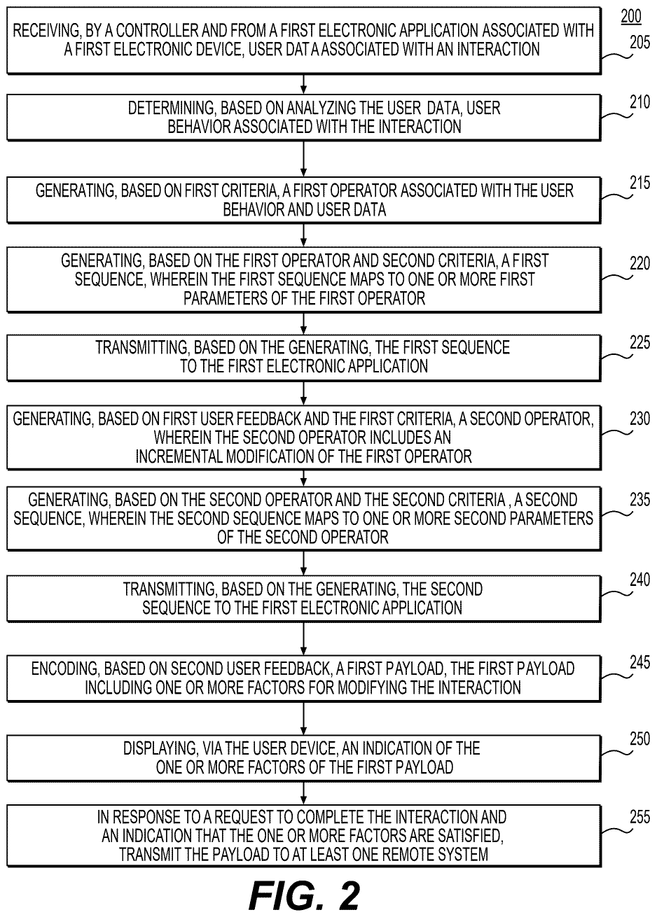

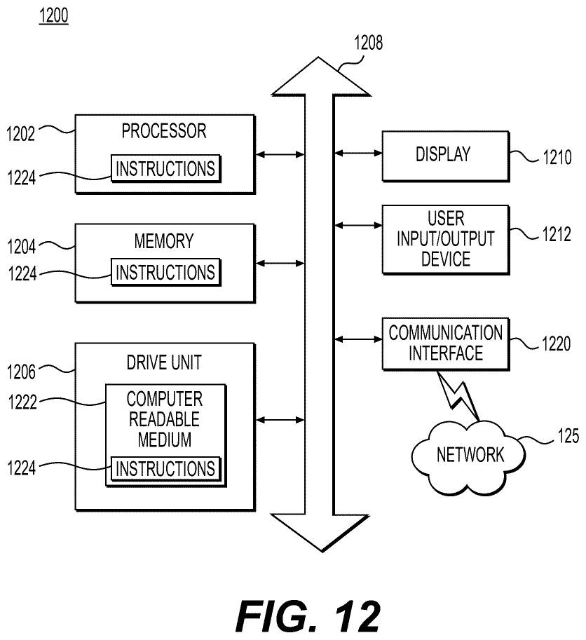

FIG. 2 depicts a method 200 of generating a personalized offer according to example embodiments. In some aspects, the method 200 may be performed by environment 100, which may include computer system 1200 described with reference to FIG. 12 below.

At step 205, the method may include receiving, by a controller and from a first electronic application associated with a first electronic device, user data associated with an interaction. For example, a conversational AI-bot associated with conversational AI-bot 120 may receive from user device 105 information regarding a user's interaction with a merchant website during an online shopping experience. Alternatively, the controller may include an artificial intelligence (AI) module that controls one or more conversational AI agents (AI-bots). In some instances, the controller may be orchestration layer 510 as described below in the description of FIG. 5.

At step 210, the method may include determining, based on analyzing the user data, user behavior associated with the interaction. For example, the orchestration layer of conversational AI-bot 120 may analyze the received user information and determine, for example, whether the user is interested in purchasing a particular product on the particular website. In some instances, the user data may indicate that the user has placed an item in a check-out cart. In other instances, the user data may indicate the user dedicated significant time viewing a particular product page. Additionally, analyzing the user data may include determining whether a user behavior metric surpasses a predetermined threshold.

At step 215, the method may include generating, based on first criteria, a first operator associated with the user behavior and user data, wherein the first operator includes one or more first parameters. For example, the conversational AI-bot 120 may obtain user history data and, based on analyzing the user history data, generate a first offer to incentivize the user to purchase or complete the purchase of the particular product or service. The first offer may include coupons, cashback offers, loyalty points, buy-one-get-one deals, gift cards, free shipping, tiered discounts, referral bonuses, rebates, membership discounts, early-bird pricing, and other incentives. The offer may operate on a price or a total during a check-out procedure.

User history data may include not only the individual's browsing patterns, product views, and purchase history, but also records of prior interactions with financial incentives, such as coupons, discounts, cashback offers, or loyalty rewards. By analyzing how the user responded to these past incentives, for example, the user history data may indicate whether the user redeemed the proffered incentives, ignored them, or made additional purchases. The conversational AI-bot 120 may identify patterns and preferences that suggest which types of incentives are most likely to be effective for the user at this time and in the future. This information may then be used to generate personalized financial incentives tailored to the individual, increasing the likelihood of engagement, conversion, or repeat purchases. Incorporating both behavioral and historical incentive data may allow the conversational AI-bot 120 to make more informed decisions, delivering offers that are aligned with the user's demonstrated interests and responsiveness.

At step 220, the method may include generating, based on the first operator and second criteria, a first sequence, wherein the first sequence maps to the one or more first parameters of the first operator. After determining a personalized offer for the user, the conversational AI-bot 120 may analyze second criteria, such as user behavioral and/or emotional data, to determine a favorable manner in which to present the personalized offer to the user, as a first step in negotiating with the user. For example, the conversational AI-bot 120 may determine to present the first offer in a happy, excited manner. In other instances, the conversational AI-bot 120 may decide to present the first offer in a quick, hurried manner. To the conversational AI-bot 120, the manner in which the offer is presented, that is, the words used and the tone conveyed, may be a first sequence of words presented the user. The offer may include one or more first parameters, such as an amount off the product, an expiration time of the offer, different products to which the offer may be applied, different merchants that may honor the offer, and other parameters relating to the incentive. Other first parameters may include a minimum purchase requirement, a validity period or expiration date, eligible products or categories, maximum number of redemptions per user, stackability with other offers, geographic or channel restrictions, and any special conditions that must be met to qualify for the offer.

For example, the one or more factors may include a guardrail factor. The guardrail factor may be a limiting factor which defines a minimum allowable sale price, a maximum permitted discount value, or other limiting factor associated with the product. In some instances, the guardrail factor may prevent a transaction from executing a sale that exceeds a defined discount or drops a price of a product below a predetermined threshold amount. For example, a guardrail factor may include a rule that states “no matter what else is true, never sell this product below [price y].” One or more guardrail factors may be taken into consideration when generating an offer. The guardrail factors may ensure that when an offer is accepted by the user and used to operate on the transaction (i.e., the price of the item, a total of the purchase, etc.), the output of the interaction is in compliance with pricing rules, safeguard revenue parameters, or other limiting factors.

Additionally, conversational AI-bot 120 (or AI architecture 600 as described below in the description of FIG. 6) may monitor and analyze the generated offer for AI generated hallucinations. Hallucination monitoring may focus on ensuring that automatically generated offers, limits, and eligibility criteria remain valid, compliant, and consistent with contextual data, such as vendor rules, inventory, margin thresholds, business rules, etc. Hallucination monitoring may employ a multi-layered analytical framework that integrates factual verification, contextual validation, and model-internal telemetry to detect and prevent invalid or fabricated offer data. Factual verification modules may cross-check generated values, such as discount percentages, expiration dates, product SKUs, point thresholds, etc., against an authoritative database or business logic engine. Contextual alignment components may compute consistency scores between the output of conversational AI-bot 120 and predefined promotion policies to ensure that the generated offer adheres to purchase limits, redemption caps, loyalty constraints, and other parameters. Linguistic and semantic analysis may identify anomalies such as illogical descriptions, contradictory terms, or offers that deviate from standard templates. At the model level, token-level uncertainty, log it variance, and embedding divergence may be monitored to flag unstable generations that could produce invalid offer parameters. A resulting hallucination risk score may trigger automated correction, regeneration under tighter constraints, or escalation for human review before offer deployment. In the case of a hallucination-based offer being presented to the user, conversational AI-bot 120 may reverse the offer, abort the associated interaction, or both. For example, in an obvious hallucination where the generated offer presents an aggregate price of $1, a vender may abort the offer, conversational AI-bot 120 may re-generate the offer, or both. The user may be previously notified of such actions through, for example, a terms and conditions clause located on and generated with the offer.

User emotional data may include captured affective responses and sentiments of a user, providing additional insight into how a user will respond to the different manners in which an offer may be presented. User emotional data may include data associated with user preferences, engagement, and potential purchase behavior. Such data may be obtained through a variety of sources, including facial expressions detected via cameras, which may indicate reactions like excitement, interest, or frustration when viewing products; voice tone and speech patterns from calls or voice commands, which may reflect enthusiasm, hesitation, or dissatisfaction; and physiological signals, such as heart rate or skin conductance, which may reveal levels of arousal or stress associated with particular products or content. Emotional information may be inferred through sentiment analysis of text-based communications, including social media posts, reviews, or messages, where positive, negative, or neutral language conveys user attitudes toward a product or brand. Even interaction patterns, such as rapid scrolling, repeated revisits to certain content, or prolonged pauses, may indirectly indicate emotional engagement or frustration. By analyzing these emotional signals in conjunction with user behavioral data, the conversational AI-bot 120 may better predict user whether the user will accept the offer based on the manner in which the offer was presented. Further, the conversational AI-bot 120 may better determine user interest in the product, identify products that evoke positive responses, and deliver personalized recommendations or targeted financial incentives that align with the user's emotional and experiential context, ultimately improving engagement and increasing the likelihood of conversion.

The user behavior analysis employs a multi-layered convolutional neural network specifically designed for temporal pattern recognition in user interaction sequences. The network architecture includes temporal convolution layers with kernel sizes optimized for detecting behavioral patterns across different time scales (1-second micro-interactions, 10-second engagement patterns, and 60-second session behaviors). The system implements a novel attention mechanism that weighs recent user actions more heavily than historical data, using exponential decay functions to prioritize immediate behavioral indicators.

The offer generation algorithm utilizes a reinforcement learning approach with a custom reward function that balances conversion probability, profit margins, and user satisfaction metrics. The system maintains separate neural network models for different product categories and user segments, with model parameters updated through gradient descent optimization based on real-time feedback from completed transactions.

At step 225, the method may include transmitting, based on the generating, the first sequence to the first electronic application. For example, the conversational AI-bot 120 may transmit to user device 105 the generated offer. In some instances, the offer may be presented to a user on user device 105 via a pop-up user interface. In other cases, the offer may be part of an ongoing conversation between the user and the conversational AI-bot 120 in a chat box.

At step 230, the method may include generating, based on first user feedback and the first criteria, a second operator, wherein the second operator includes an incremental modification of the first operator. The feedback may be real-time feedback. For example, the user may decline the first offer and transmit this feedback to conversational AI-bot 120. Next, conversational AI-bot 120 may further analyze the first criteria based on the user feedback and generate a second offer. In the spirit of negotiation (or haggling), conversational AI-bot 120 may generate the second offer based on an incremental modification to the first offer. For example, the second offer may be 20% off the price of the product where the first offer was 15% off the price of the product. The second offer may include one or more second parameters, such as the discount amount or percentage, the minimum purchase requirement, the validity period or expiration date, eligible products or categories, maximum number of redemptions per user, stackability with other offers, geographic or channel restrictions, and any special conditions that must be met to qualify for the offer.

At step 235, the method may include generating, based on the second operator and the second criteria, a second sequence, wherein the second sequence maps to one or more second parameters of the second operator. For example, conversational AI-bot 120 may determine a second manner in which to present the second offer to the user. For example, the second offer may be presented in a friendly and engaging manner, commenting about the interaction with the user: “because I'm enjoying this conversation with so much, I'm going to up the offer to 20%!” Alternatively, the second offer may be presented in an understandable tone, such as “I understand that times are difficult right now. Would 20% off your total shopping trip help you out with this purchase?” In this way, conversational AI-bot 120 may engage in a learned negotiation with the user, much like when the user shops in a store.

At step 240, the method may include transmitting, based on the generating, the second sequence to the first electronic application. Like transmitting the first sequence, the conversational AI-bot may transmit the second sequence to the user via user device 105.

At step 245, the method may include encoding, based on second user feedback, a first payload, the first payload including one or more factors for modifying the interaction. For example, the second user feedback may include an indication of user acceptance of the second offer. When the user accepts the offer, conversational AI-bot 120 may generate a unique code for the user by encoding a payload of a signal. The payload may be encoded by converting its data into a specific format or protocol, ensuring that the unique code may be securely transmitted, correctly interpreted, and processed by the receiving system. The unique code may include instructions on how to modify the user's purchase associated with the shopping interaction with the merchant's website. For example, the unique code may indicate to take 20% off the total of user's purchase. The first payload may be transmitted to, for example, user device 105 in response to receiving an authenticated payload over a standard secure protocol. For example, the user associated with user device 105 may need to log into a portal of external system(s) 110 in order to receive and employ an offer.

At step 250, the method may include displaying, via the user device, an indication of the one or more factors of the first payload. For example, the conversational AI-bot may transmit the user device 105 the unique code and display the unique code on display/UI 105A. The unique code may indicate one or more factors, or requirements, needing to be fulfilled in order to earn the reward during checkout. The factors may be, for example, a time limit (e.g., “only two hours left to redeem!”) or a total amount needed to purchase (e.g., “only $10 more for free shipping!”).

At step 255, the method may include transmitting, in response to a request to complete the interaction and an indication that the one or more factors are satisfied, the payload to at least one remote system. For example, conversational AI-bot 120 may receive an indication from the user that the user would like to check out and complete the transaction. Additionally, conversational AI-bot 120 may receive an indication that the one or more factors have been fulfilled. Conversational AI-bot 120 may then transmit the payload to a remote system, such as external system(s) 110. In some instances, external system(s) 110 may include a payment processor, a merchant or vendor, or other entity associated with the interaction. Additionally, conversational AI-bot 120 may take the user to the user's cart, a payment processor, or a merchant associated with the interaction. Further, the remote system may include an application programming interface associated with a second electronic device.

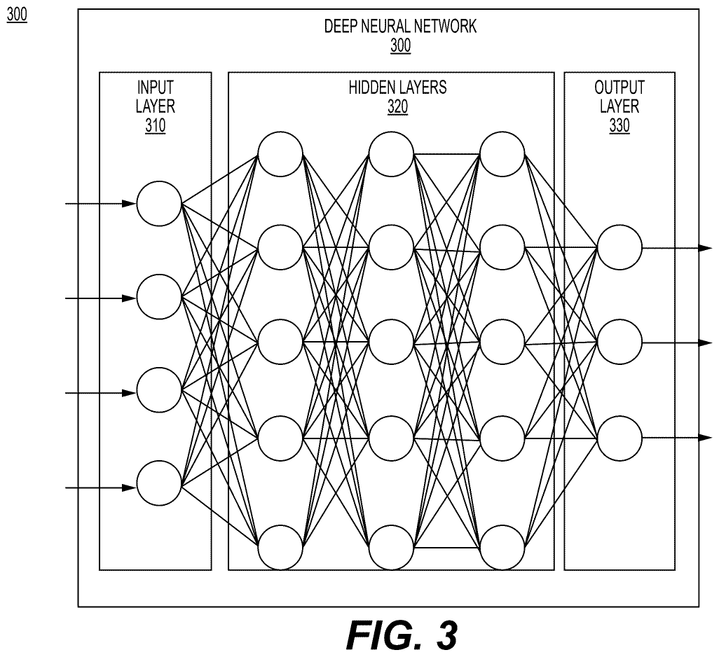

FIG. 3 depicts a diagram of a deep neural network architecture 300 according to example embodiments. The deep neural network may include an input layer 310, one or more hidden layers 320, and an output layer 330. Input data may be provided to input layer 310, which then passes the data sequentially through each of the one or more hidden layers 320. Each of the one or more hidden layers 320 may perform a unique transformation on its input, and output the transformed data to a next hidden layer of the one or more hidden layers 320 or to the output layer 330. The one or more hidden layers 320 may include one or more projection layers, classification layers, or other transformation layer depending on the type of deep neural network architecture provided. Additionally, the deep neural network may include a collection of interconnected and weighted nodes (“neurons”) that transform input data through weighted connections and activation functions. One or more weights, or parameters, of the weighted connections and weighted nodes may be updated as the machine learning model is trained, pretrained, and/or learning.

Some machine learning models, particularly deep neural networks, are often trained using a two-step process involving pretraining and fine-tuning. Pretraining may begin with a large, general-purpose dataset that allows the model to learn broad patterns and representations in the data. During this phase, input data is fed into the network, and the model's internal parameters, or weights, are iteratively adjusted to reduce prediction error. Optimization techniques, such as stochastic gradient descent, may guide this adjustment by calculating the gradient of a loss function and updating the weights in the direction of minimization. This process may be repeated over many iterations until the model reaches a state of convergence, which is generally defined as the point where further decreases in the loss function become negligible or the loss meets a predefined threshold. Convergence may indicate that the model has sufficiently learned the general patterns in the training data and that additional training would yield diminishing returns.

After pretraining, the model may undergo fine-tuning, a phase in which it is adapted to a more specific task or dataset. Fine-tuning may involve feeding a targeted dataset into the pretrained model and adjusting the weights further so that the model's representations better match the requirements of the specialized task. During this process, the model's performance may be frequently evaluated using a validation set, often at the end of each training epoch, to monitor improvements and to determine the optimal point at which to stop fine-tuning. These steps may ensure that the model does not overfit the fine-tuning dataset while maximizing task-specific performance. Once fine-tuning is complete, the model's final adjusted weights may be saved. These weights may be later retrieved and loaded whenever the trained model is deployed to make predictions on real-world datasets, enabling the AI system to leverage both its general pretraining knowledge and its task-specific adaptations.

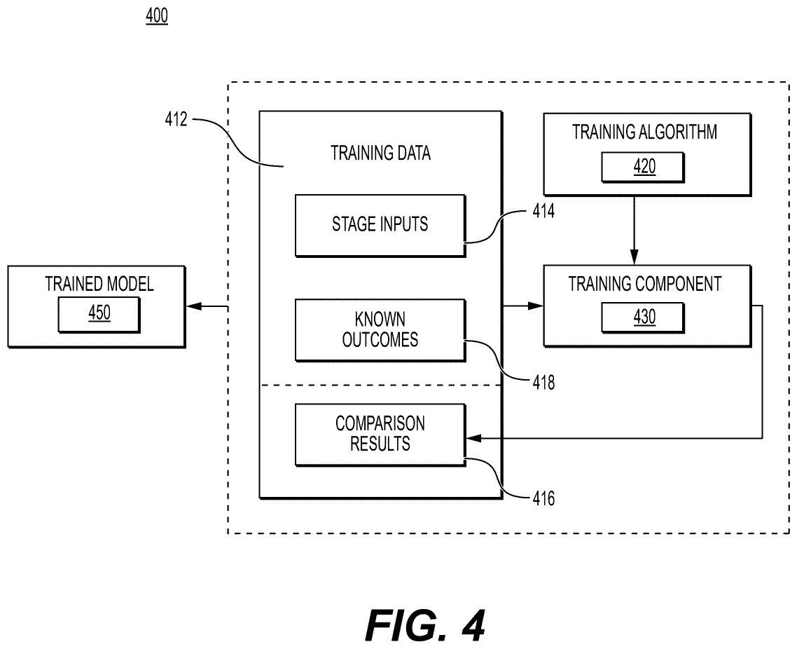

FIG. 4 depicts a flow diagram 400 for training a machine-learning model, according to example embodiments according to example embodiments. As shown in flow diagram 400 of FIG. 4, training data 412 may include one or more of stage inputs 414 and known outcomes 418 related to a machine learning model to be trained. The stage inputs 414 may be from any applicable source including a component or set shown in the figures provided herein. The known outcomes 418 may be included for machine learning models generated based on supervised or semi-supervised training. An unsupervised machine learning model might not be trained using known outcomes 418. Known outcomes 418 may include known or desired outputs for future inputs similar to or in the same category as stage inputs 414 that do not have corresponding known outputs.

The training data 412 and a training algorithm 420 may be provided to a training component 430 that may apply the training data 412 to the training algorithm 420 to generate a trained machine learning model 450. According to an implementation, the training component 430 may be provided comparison results 416 that compare a previous output of the corresponding machine learning model to apply the previous result to re-train the machine learning model. The comparison results 416 may be used by the training component 430 to update the corresponding machine learning model. The training algorithm 420 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 400 may be a trained machine learning model 450.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

FIG. 5 depicts a system 500 including an orchestration layer according to example embodiments. As depicted in FIGS. 5, system 500 includes the user associated with user device 105, an API 505, an orchestration layer 510 and services 520. The user may interact with services 520 independently or through orchestration layer 510 via API 505. Services 520 may include merchants, vendors, or other online services. Further, services 520 may be external system(s) 110 as described above in the description of FIG. 1. Orchestration layer 510 may be part of conversational AI-bot 120, or, alternative, part of an AI system that includes conversational AI-bot 120. Orchestration layer 510 may be an artificial intelligence (AI) orchestration layer.

For example, a client may interact with services 520 through an API Gateway, which serves as a centralized entry point to manage, route, and secure incoming requests. Orchestration layer 510 may act as a control layer that may monitor user interactions with services 520 and negotiate with the user to complete and incentivize purchases. Further, orchestration layer 510 may generate personalized codes for the user redeemable at services 520.

FIG. 6 depicts an example AI architecture 600 according to example embodiments. As depicted in FIGS. 6, AI architecture 600 may include collective learning module 605, e-commerce systems 610, integration layer 615 databases 620, central analytics module 625, negotiation logic module 630, monitoring module 635, AI offer generation module 645. AI architecture 600 may include orchestration layer 510 as described above in the description of FIG. 5. AI architecture 600 may include conversational AI-bot 120 and user device 105 as described above in the description of FIG. 1.

Orchestration layer 510 may act as a controller, managing and coordinating the interactions between underlying services to ensure smooth execution of workflows. For example, orchestration layer 510 may interact with collective learning module 605, e-commerce systems 610 via integration layer 615, databases 620, central analytics module 625, negotiation logic module 630, user device 105 via monitoring module 635 and conversational AI-bot 120, and AI offer generation module 645. Conversational AI-bot 120 may include, for example, additional conversational IA-agents.

AI architecture 600 may use orchestration layer 510 that may supervise multiple conversational AI-bot 120. Orchestration layer 510 may include machine learning modules, deep learning neural networks, or other AI capabilities. Each conversational AI-bot 120 may run on a large language model (LLM) foundation capable of natural conversation and is guided by dynamic prompts and policy instructions defined by orchestration layer 510. For example, the orchestration layer 510, an AI module, may determine which agent configuration to deploy for a given session, what contextual data (vendor rules, inventory, margin thresholds) to include, and how to adjust negotiation logic via negotiation logic module 630 throughout the interaction. The AI architecture 600 may monitor conversation context, sentiment, and key indicators of purchase intent via monitoring module 635. When orchestration layer 510 detects that a customer is likely to buy (or is hesitating), orchestration layer 510 may trigger the offer-generation process via generation module 645. Prompt templates may be retrieved from databases 620 may be automatically and dynamically populated templates. The templates may be populated with values such as {product_info}, {margin_band}, {inventory_status}, and {customer_state}. These templates may ensure each interaction follows brand-specific negotiation guidelines while maintaining flexibility for individual customers. Additionally, each element in AI architecture 600 may include one or more machine learning modules, deep learning neural networks, and/or other AI capabilities. Table 1 further describes the different components of AI architecture 600.

TABLE 1

| Component/ | | | |
|---|---|---|---|
| Feature | Purpose | Key Technical Details | Notes/Benefits |
| Orchestration | Manages agent | Dynamic prompt injection; context- | Adapts negotiation |
| Layer 510 | prompts and | based configuration; monitors | strategy in real time |
| | behavior | conversation state | |
| Conversational | Engage | LLM-based; interprets intent and | Natural engagement |
| AI-bot 120 | customers | sentiment; responds using vendor- | that detects readiness |
| | | specific style guides | to buy |
| AI Offer | Creates or | Calls vendor APIs (e.g., Shopify | Enables real-time, |
| Generator | retrieves | Discounts API); validates and activates | one-time personalized |
| Module 645 | discount codes | codes; uses policy constraints | offers |
| Collective | Improves | Aggregates anonymized data; | Increases offer success |
| Learning | decision | automated retraining; supports local or | rate without manual |
| Module 605 | logic | global modes | tuning |
| Databases 620 | Holds rules, | Structured tables for products, | Fast retrieval, privacy |
| | policies, | margins, offers, results; hashed | protection |
| | and data | identifiers | |
| Integration | Connects to | REST APIs and webhooks; token- | Platform-agnostic and |
| Layer | e-commerce | based authentication; HTTPS | secure |
| 615 | systems | encryption | |
| Technical | — | Faster negotiation, adaptive | Tangible e-commerce |
| Advantages | | optimization, lower cart abandonment | performance gains |

When the system reaches a point where an offer is warranted, the AI-bot may construct a Discount Request Object (DRO) that contains the relevant transaction context. The DRO may include: a product identifier, a discount type and value, an expiration window, and relevant policy tags (for example, “gift purchase” or “repeat customer”). The AI-bot may transmit the request through the vendor's existing e-commerce API (e.g., Shopify's Discounts API or equivalent). The API may either return an existing matching offer or creates and activates a new one-time code in the store's database. The generated code may be immediately available for the customer within the chat interface, accompanied by checkout instructions. The transaction details, including timing and outcome, may be logged for future learning cycles via collective learning module 605. All API communications may use standard secure protocols (HTTPS) and authenticated tokens. Vendor and customer identifiers may be hashed before storage to preserve privacy.

Each completed or abandoned conversation may produce structured event data, such as product category, offer parameters, timing, customer sentiment, and success outcome. This data may feed into a central analytics module 625 that may continuously update the decision logic (at negotiation logic module 630) for offer timing, discount magnitude, and incentive type. The learning process may be fully automated. By default, anonymized data from all vendor instances may contribute to a collective learning model in collective learning module 605, allowing the system to recognize broad behavioral patterns. Vendors may opt for a private learning mode, where only their own store data influences updates and is not used to train the broader system. The orchestration layer 510 may automatically sync new rules and weightings at regular intervals, ensuring each agent operates with the most effective negotiation strategies.

The collective learning module 605 may implement advanced machine learning techniques for cross-platform knowledge transfer. In some embodiments, the system may utilize federated learning approaches to share insights between merchant platforms while maintaining data privacy and merchant-specific customizations. Neural network models may be trained on anonymized interaction data to identify universal patterns in customer behavior and negotiation effectiveness.

Customer segmentation algorithms may categorize users based on behavioral patterns, demographic indicators, and interaction history. The system may develop personalized negotiation strategies for different customer segments, adjusting offer timing, discount magnitudes, and incentive types based on segment-specific preferences. Machine learning models may continuously refine segmentation criteria based on interaction outcomes and conversion success rates.

A/B testing capabilities may be integrated into the negotiation process to evaluate the effectiveness of different approaches. The system may randomly assign users to different negotiation strategies and measure comparative success rates. Statistical analysis of A/B test results may inform automatic updates to negotiation algorithms and offer generation parameters, enabling continuous optimization without manual intervention.

The AI offer generation module 645 may implement sophisticated algorithms for creating unique discount codes with embedded security features. In some embodiments, each generated code may include cryptographic elements to prevent unauthorized duplication or modification. The system may generate codes using algorithmic patterns that incorporate timestamp data, user identifiers, and merchant-specific parameters to ensure uniqueness across all transactions.

Code validation mechanisms may include real-time verification against merchant inventory systems and pricing databases. The system may perform constraint checking to ensure generated offers comply with merchant policies, including maximum discount limits, product category restrictions, and usage frequency limitations. In some aspects, the validation process may include fraud detection algorithms to identify potentially suspicious redemption patterns.

The offer generation process may incorporate real-time inventory checking to ensure product availability before presenting offers to users. The system may interface with merchant inventory management systems through APIs to verify stock levels and adjust offer parameters accordingly. In cases where inventory is limited, the system may generate time-sensitive offers with shorter expiration windows to encourage immediate purchase decisions.

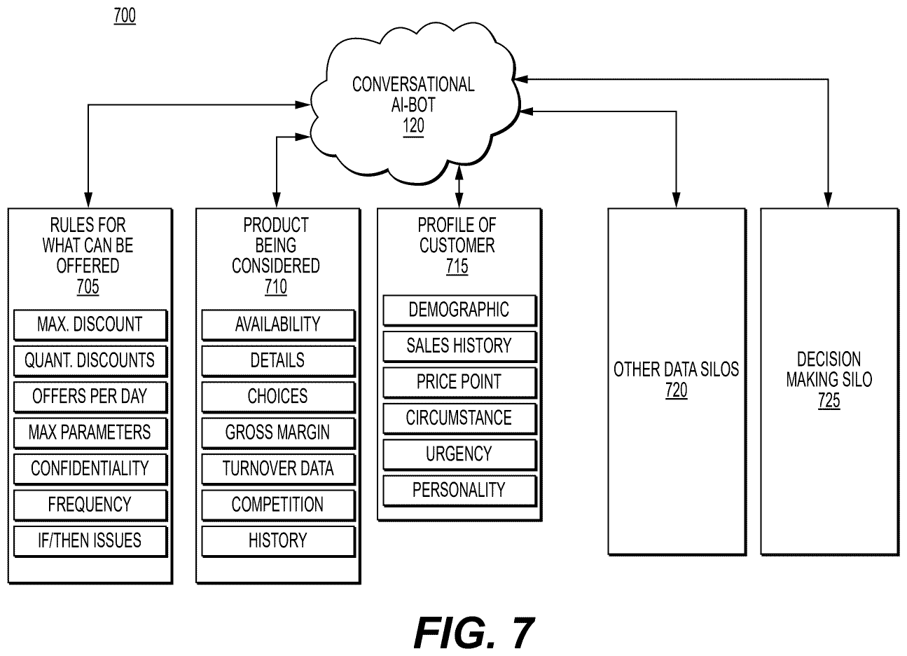

FIG. 7 depicts an AI communication module 700 according to example embodiments. As depicted in FIG. 7, conversational AI-bot 120 may analyze different data in order to determine one or more incentives to offer to the shopper (e.g., the user). At 705, conversational AI-bot 120 may analyze rules or policies instituted by associated third-party entities. Interested third parties associated with online shopping interactions may include payment processors, banks, logistics and shipping companies, marketplace platforms, software and hosting providers, advertising and analytics firms, regulators, tax and customs authorities, suppliers and manufacturers, returns and warranty service providers, and affiliate or marketing partners, merchants, vendors, and other interested entities. Data analyzed may include a maximum discount offered, a quantity of discounts offered, a number of offers presented to the shopper over a time period (e.g., a day, a week, etc.), confidentiality factors associated with the offer, a frequency of the offer or different types of offers, consequences of the offer (e.g., whether the offer may be correctly enforced to avoid errors or misuse), or other rules or policies. The rules and policies may be located in database(s) 115A or other external database.

At 710, conversational AI-bot 120 may analyze one or more products being considered by the user during the shopping interaction. For example, conversational AI-bot 120 may analyze the Availability of the one or more products, details of the one or more products, such as the amount available at the merchant, preferred style or color, available size, or other product characteristic, available choices of the product, the gross margin, turn over data, competition of the product, product availability at other merchants, history of the product, or other product information.

At 715, conversational AI-bot 120 may analyze the customer (e.g., user, shopper) profile. The profile data may include demographic information (e.g., age, location, income segment, etc.), sales history, general price point, current circumstances, any detected urgency from the customer, personality information, engagement with past promotions, loyalty program status, and any previous coupon usage or redemptions, as these factors help tailor the offer to maximize offer relevance and redemption likelihood. At 720, the conversational AI-bot 120 may analyze other data silos, such as web and app analytics like browsing patterns and cart activity, third-party demographic or behavioral data, social media interactions, fraud or risk scoring records, and other data silos relating to managing risk and maximizing the likelihood of discount code redemption. At 725, conversational AI-bot 120, via, for example, orchestration layer 510, may transfer all the relevant information into a decision making silo. The decision making silo may include negotiation logic module 630, central analytics module 625, collective learning module 605, AI offer generation module 645, and other modules associated with orchestration layer 510 as depicted above in FIG. 6.

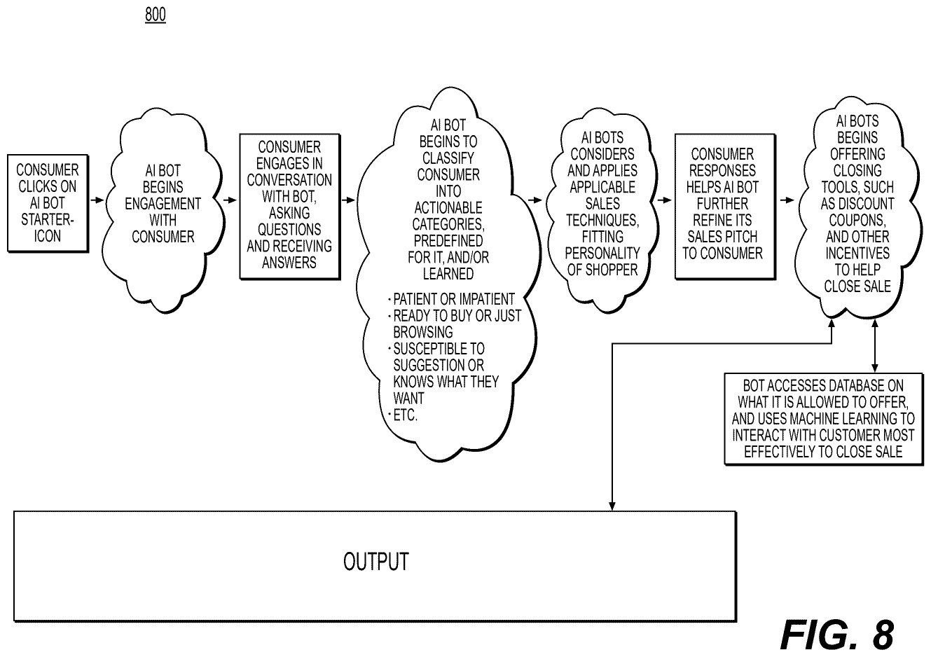

FIG. 8 depicts an example method 800 of interacting with an AI communication module according to example embodiments. At 805, a user may click on an AI-bot starter icon associated with conversational AI-bot 120. At 810, conversational AI-bot 120 may begin engagement with the user with a greeting or an offer to help the user with the interaction, for example. Conversational AI-bot 120 engagement may be determined based on an analysis of the user history data and/or user behavioral data. At 815, the user may engage in conversation with conversational AI-bot 120. The user may answer questions posed by conversational AI-bot 120 and/or ask further questions to conversational AI-bot 120.

At 825, conversational AI-bot 120 may begin to classify information from the user into actionable categories. The categories may be predefined or generated based on learning techniques. For example, the conversational AI-bot 120 may determine whether the user is currently acting patiently or impatiently, whether the user is ready to purchase or is deliberating purchasing the product, whether the user would be open to suggestions or whether the user is firm on purchasing the product, and other user analysis.

At 830, conversational AI-bot 120 may consider and apply applicable sales techniques taking into consideration the personality, emotional status, and other negotiation related parameters. Applicable sales techniques may include guiding a use from interest of a product to completing a purchase of the product by addressing their needs and emphasizing value. Common approaches may include the assumptive close, which treats the sale as already decided; the urgency or scarcity close, highlighting limited-time offers or stock; and the summary close, which recaps agreed-upon benefits before asking for commitment. Other sale techniques may include the alternative choice close, offering two options both leading to a purchase, the direct close, simply asking for the sale, and the trial close, which tests readiness with questions like “Does this solution meet your needs?” Further sale techniques may include emphasizing specific benefits, using social proof to create urgency, and conditional if/then closes, where a deal is contingent on certain conditions. Conversational AI-bot 120 may tailor these strategies to the customer's personality, buying stage, and the complexity of the product or service. At 835, conversational AI-bot 120 may further refine its sales pitch or negotiating tactic based on additional conversation with the user.

At 840, conversational AI-bot 120 may being offering closing tools, such as discount coupons and other incentives to help close the sale. Conversational AI-bot 120 may access databases, for example database(s) 115A, at 845 to determine the parameters of the offer (e.g., what discounts are allowed by vendors, merchants, etc.). Conversational AI-bot 120 may use continuous learning (e.g., machine learning via AI offer generation module 645 and negotiation logic module 630) to interact with the customer most effectively to close the sale.

At 850, conversational AI-bot 120 may produce output for the AI system, the user, and/or other related entity. For example, when the sale is complete, conversational AI-bot 120 may identify and create a file on the user (ideally, by email address or other unique identifier) which conversational AI-bot 120 may invoke in future interactions with the user. Conversational AI-bot 120, or other AI module, may invoice or add to an accounting statement whatever is earned from this sale, if an applicable to pricing model is in play. Conversational AI-bot 120, or other AI module may use data gained from interaction to learn and improve user interactions in the future. Additionally, conversational AI-bot 120, or other AI module, may take such other steps as are appropriate given what has happened in the interaction, such as communicating to recommended vendors, friends, etc. and other steps.

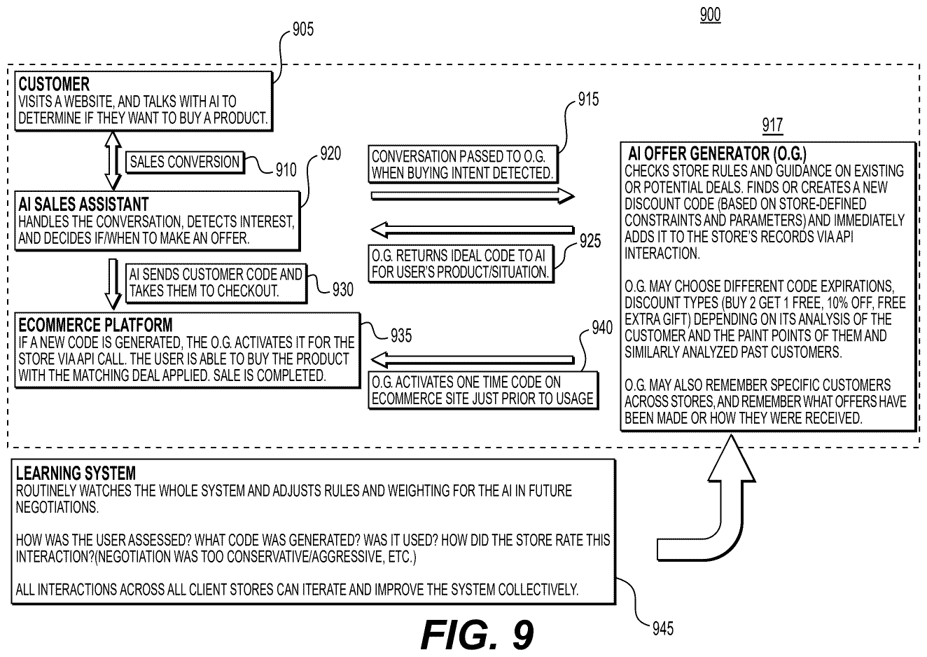

FIG. 9 depicts a flowchart 900 of an example of interacting with an AI offer module according to example embodiments. Flowchart 900 may incorporate AI architecture 600 as described above in FIG. 6 and environment 100 as described above in FIG. 1. Flowchart 900 may employ computer system 1200 as described below in FIG. 12.

At 905, a user (customer) associated with user device 105 may visit and interact with a website. The website may be a shopping website or a website offering services. At 910, the user may interact with conversational AI-bot 120. Conversational AI-bot 120 may analyze the user conversation and other data to determine whether the user wants to purchase the product or service. Alternatively, conversational AI-bot 120 may transmit the conversation information to orchestration layer 510. Orchestration layer 510 may determine which module to transmit the data to or from which model data is needed in order to proceed with purchasing negotiations with the user. For example, orchestration layer 510 may determine that additional information regarding the emotional state of the user is required and request such information from monitoring module 635, databases 620 or other module. In other instances, orchestration layer 510 may transmit all relevant information to central analytics module 625 and negotiation logic module 630 to determine whether to further the conversation with the user.

At 915, after determining that the user is interested in purchasing the product or service, conversational AI-bot 120 may transmit the conversation data to AI offer generation module 645 via orchestration layer 510. At 917, AI offer generation module 645 may receive information regarding store rules and merchant policies, and guidance on existing or potential deal from databases 620. Further, orchestration layer 510 may transmit relevant information regarding the product, the user, the conversation, or other data to one or more AI offer generation module 645, central analytics module 625, or other module. For example, AI offer generation module 645 may analyze rules and polices to determine one or more potential offers. Additionally, AI offer generation module 645 may find or creates a new discount code based on, for example, merchant-defined constraints and parameters. AI offer generation module 645 may add any newly generated discount code to the merchant's records via, for example, an API interaction. AI offer generation module 645 may choose different code expirations, discount types (e.g., buy 2 get 1 free, 10% off, free extra gift) depending on user data, similarly analyzed past customers, and other additional factors. AI offer generation module 645 may also analyze information regarding specific customers across stores, and analyze what offers have been made and how the offers were received by the customers.

At 920, AI offer generation module 645 may transmit to conversational AI-bot 120 an ideal discount code or offer for the current situation. The ideal discount code may be generated based on information related to the product or service but also information related the user. The user information (data) may include user history data, current user emotional status, time of day, user preferences, or other user data.

At 925, conversational AI-bot 120 may manage the conversation, detect user interest in the product, detect one or more emotional cues from the user, and determine whether offering the user an incentive would help to close to the sale. Conversational AI-bot 120 may determine the timing of the offer and the manner in which the offer is made based on user history data and/or user behavior data. In some cases, conversational AI-bot 120 may transmit user data, conversational data, information regarding the ideal discount code from AI offer generation module 645, and other relevant information to negotiation logic module 630 via orchestration layer 510. Alternatively, orchestration layer 510 may determine to transmit relevant information to negotiation logic module 630. For example, negotiation logic module 630 may obtain analytical data concerning the user and/or the product from central analytics module 625. Further, current user information, such as the current user state or information regarding webpages with which the user interacts, and other relevant information, may be transmitted to negotiation logic module 630 from monitoring module 635. Negotiation logic module 630 may analyze the information and data to determine the best negotiation strategy or manner in which to present the offer to the user.

When the user declines the offer, or provides a counter offer, conversational AI-bot 120 may determine a next step in the negotiation process. For example, conversational AI-bot 120 (or orchestration layer 510 or negotiation logic module 630) may acquire and analyze further user data or product data to determine a second offer or accept the counter offer. The second offer may be an incremental modification to the first offer. Alternatively, the second offer may include a different incentive, such as free shipping or promotional points. The user and conversational AI-bot 120 may engage in multiple iterations of negotiation steps.

The first offer and the second offer may include contextual data. Contextual data may include time and date information, location, device or platform used, environmental conditions, user behavior and interactions, situational factors like promotions or loyalty status, social or operational context. Contextual data may also include details related to the offer such as discount amount, expiration date, applicable products or categories, usage history, and redemption conditions.

At 930, conversational AI-bot 120 may receive information that the user accepts an offer. Conversational AI-bot 120 may send the accepted offer to the user and take the user to a checkout webpage. For example, conversational AI-bot 120 may communicate with a merchant associated with an e-commerce system of e-commerce systems 610 via integration layer 615. Conversational AI-bot 120 may send user to a checkout page of the merchant and apply the code to a shopping basket or checkout form. If a unique customer code is generated, conversational AI-bot 120 (or orchestration layer 510) may, at 935, transmit the customer code to e-commerce systems 610 via integration layer 615. Additionally, at 940, AI offer generation module 645 may activate the customer code (e.g., a one-time, single use code uniquely generated for the user) at e-commerce systems 610 prior to the user checking out. Integration layer 615 may communicate with e-commerce systems 610 via an API call. The user is then able to purchase the product or service with the accepted offer applied to the purchase. The sale may then be complete.

During this process, at 945, collective learning module 605, monitoring module 635, orchestration layer 510, and/or other additional modules may continuously monitor the negotiation process and automatically adjust one or more rules and/or AI weighting features for future negotiations. For example, collective learning module 605 may determine how the user was assessed, what code was generated, details regarding how the code was used, how the merchant rate the interaction, how did the user rate the interaction, the level of negotiations (for example, on a conservative to aggressive scale), and other relevant features. The client interactions may be stored, for example in databases 620. The interactions may be analyzed to improve the system collectively.

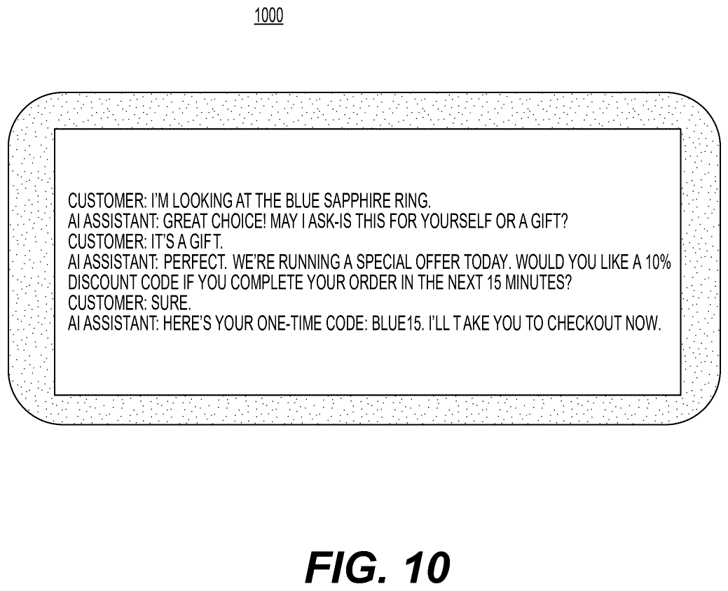

FIG. 10 depicts an example negotiation 1000 based on a discount code according to example embodiments. As depicted in FIG. 10, a conversational AI-bot 120 may interact with a user associated with user device 105. The conversational AI-bot 120 may ask questions and acquire information related to the user's intention to determine both an offer and a manner in which to present the offer. In this instance, the customer may not end up using the code, and conversational AI-bot 120 may note that a 15 minute 10% deal for a gift did not succeed. Future offers may opt to be shorter or longer times, higher discounts, and/or offer other perks on the order like gift wrapping, gift cards, or free expedited shipping.

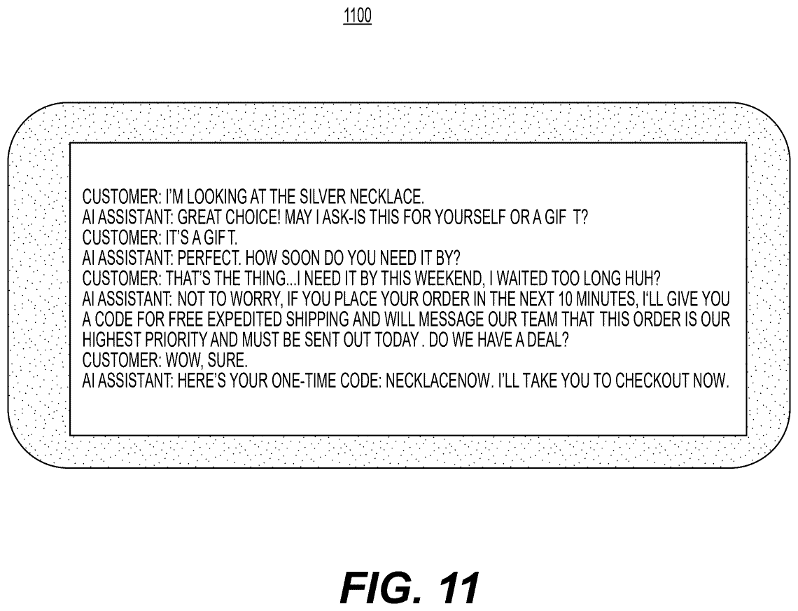

FIG. 11 depicts an example negotiation 1100 based on an offer for expedited shipping according to example embodiments. As depicted in FIG. 10, a conversational AI-bot 120 may interact with a user associated with user device 105. The conversational AI-bot 120 may ask questions and acquire information related to the user's intention to determine both an offer and a manner in which to present the offer. In this instance, the customer (e.g., user) may use the code and the negotiation is recorded as a success.

FIG. 12 depicts a simplified functional block diagram of a computer system 1200, according to one or more embodiments according to example embodiments. As depicted in FIG. 12, computer system 1200 may be configured as the server system 115, AI architecture 600, or another system according to exemplary embodiments of this disclosure. In various embodiments, any of the systems herein may be a computer system 1200 including, for example, a data communication interface 1220 for packet data communication. The computer system 1200 also may include a central processing unit (“CPU”) as processor 1202, in the form of one or more processors, for executing program instructions. The computer system 1200 may include an internal communication bus 1208, and a storage unit 1206 (such as ROM, HDD, SDD, etc.) that may store data on a computer readable medium 1222, although the computer system 1200 may receive programming and data via network communications. The computer system 1200 may also have a memory 1204 (such as RAM) storing instructions 1224 thereon for executing techniques presented herein, although the instructions 1224 may be stored temporarily or permanently within other modules of computer system 1200 (e.g., processor 1202 or computer readable medium 1222). The computer system 1200 also may include input and output ports 1212 or a display 1210 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform. The system may include one or more sequences of instructions, which, when executed by a processor, causes a computing system to perform operations. Additionally, programming instructions stored thereon.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution. The methods described herein may be computer-implemented methods that may run on one or more software elements or hardware elements. For example, a non-transitory computer readable medium comprising one or more programming instructions, which, when executed by a processor, may cause a computing system to perform operations associated with the method.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A computer-implemented method comprising:
receiving, by a controller and from a first electronic application associated with a first electronic device, user data associated with an interaction;
determining, based on analyzing the user data, user behavior associated with the interaction, wherein the analyzing is performed by specialized hardware accelerators configured for real-time behavioral pattern detection;
generating, based on first criteria, a first operator associated with the user behavior and user data, wherein the first operator includes one or more first parameters, and wherein the first operator is generated using a multi-layered convolutional neural network with temporal pattern recognition capabilities;
generating, based on the first operator and second criteria, a first sequence, wherein the first sequence maps to the one or more first parameters of the first operator;
transmitting, based on the generating, the first sequence to the first electronic application;
generating, based on first user feedback and the first criteria, a second operator, wherein the second operator includes an incremental modification of the first operator;
generating, based on the second operator and the second criteria, a second sequence, wherein the second sequence maps to one or more second parameters of the second operator;
transmitting, based on the generating, the second sequence to the first electronic application;
encoding, based on second user feedback, a first payload, the first payload including one or more factors for modifying the interaction;
displaying, via the user device, an indication of the one or more factors of the first payload; and
in response to a request to complete the interaction and an indication that the one or more factors are satisfied, transmit the payload to at least one remote system.

2. The computer-implemented method of claim 1, wherein the controller includes an artificial intelligence (AI) orchestration layer.

3. The computer-implemented method of claim 1, wherein generating the second operator includes contextual data.

4. The computer-implemented method of claim 1, wherein transmitting the second sequence includes displaying the second sequence via a pop-up user interface on the first electronic device.

5. The computer-implemented method of claim 1, wherein analyzing the user data includes determining whether a user behavior metric surpasses a predetermined threshold.

6. The computer-implemented method of claim 1, wherein the wherein the at least one remote system includes an application programming interface associated with a second electronic device.

7. The computer-implemented method of claim 1, further comprising transmitting the first payload in response to receiving an authenticated payload over a standard secure protocol.

8. A non-transitory computer readable medium comprising one or more programming instructions, which, when executed by a processor, causes a computing system to perform operations comprising:
receiving, by a controller and from a first electronic application associated with a first electronic device, user data associated with an interaction;
determining, based on analyzing the user data, user behavior associated with the interaction, wherein the analyzing is performed by specialized hardware accelerators configured for real-time behavioral pattern detection;
generating, based on first criteria, a first operator associated with the user behavior and user data, wherein the first operator includes one or more first parameters, and wherein the first operator is generated using a multi-layered convolutional neural network with temporal pattern recognition capabilities;
generating, based on the first operator and second criteria, a first sequence, wherein the first sequence maps to the one or more first parameters of the first operator;
transmitting, based on the generating, the first sequence to the first electronic application;
encoding, based on first user feedback, a first payload, the first payload including one or more factors for modifying the interaction;
displaying, via the user device, an indication of the one or more factors of the first payload; and
in response to a request to complete the interaction and an indication that the one or more factors satisfies a predetermined threshold, transmit the payload to at least one remote system.

9. The non-transitory computer readable medium of claim 8, wherein the first electronic application is a browser extension, and the interaction is associated with a website visited by a web browser also operating on the first electronic device.

10. The non-transitory computer readable medium of claim 8, the controller includes an artificial intelligence (AI) module that controls one or more conversational AI agents.

11. The non-transitory computer readable medium of claim 8, wherein generating the first operator includes contextual data.

12. The non-transitory computer readable medium of claim 8, wherein transmitting the first sequence includes displaying the first sequence via a pop-up user interface on the first electronic device.

13. The non-transitory computer readable medium of claim 8, wherein encoding the first payload includes encrypting the first payload.

14. The non-transitory computer readable medium of claim 8, wherein the wherein the at least one remote system includes a representational state transfer application programming interface associated with a second electronic device.

15. A system, comprising: a processor; and a memory having programming instructions stored thereon, which, when executed by the processor, causes the system to perform operations comprising:
receiving, by a controller and from a first electronic application associated with a first electronic device, user data associated with an interaction;
generating, based on first criteria, a first operator, wherein the first operator includes one or more first parameters, and wherein the first operator is generated using a multi-layered convolutional neural network with temporal pattern recognition capabilities;
generating, based on the first operator and second criteria, a first sequence, wherein the first sequence maps to the one or more first parameters of the first operator;
transmitting, based on the generating, the first sequence to the first electronic application;
generating, based on first user feedback and the first criteria, a second operator, wherein the second operator includes an incremental modification of the first operator associated with the one or more first parameters;
generating, based on the second operator and the second criteria, a second sequence, wherein the second sequence maps to one or more second parameters of the second operator;
transmitting, based on the generating, the second sequence to the first electronic application;
encoding, based on second user feedback, a first payload, the first payload including one or more factors for modifying the interaction;
displaying, via the user device, an indication of the one or more factors of the first payload; and
in response to a request to complete the interaction, transmit the payload to at least one remote system.

16. The system of claim 15, wherein the controller includes an artificial intelligence (AI) orchestration layer including a large language model.

17. The system of claim 15, wherein the controller determines one or more rules associated with the first sequence or the second sequence.

18. The system of claim 15, wherein the controller monitors user behavior during the interaction.

19. The system of claim 15, wherein the first user feedback and the second user feedback is real-time feedback.

20. The system of claim 15, wherein the first operator or the second operator is based on dynamically populated templates.
